(19) United States
(12) Patent Application Publication
(10) Pub. No.: US 2026/0064702 A1
(43) Pub. Date: Mar. 5, 2026

(54) SYSTEM AND METHOD FOR USE OF IN-MEMORY DATA GRID AS A VECTOR DATABASE

(71) Applicant: ORACLE INTERNATIONAL CORPORATION, Redwood Shores, CA (US)

(72) Inventors: Aleksandar Seovic, Tampa, FL (US); Jonathan Knight, Istanbul (TR); Liyaaqatali Mukadam, Sydney (AU); Philip Chung, New York, NY (US); Sherwood Zern, Saint Cloud, FL (US); Julian Ortiz, Ruskin, FL (US); Timothy Middleton, Perth (AU)

(21) Appl. No.: 19/303,988

(22) Filed: Aug. 19, 2025

Related U.S. Application Data
(60) Provisional application No. 63/690,982, filed on Sep. 5, 2024.
(60) Provisional application No. 63/690,987, filed on Sep. 5, 2024.

(51) Int. Cl. G06F 16/2458

(52) U.S. Cl. CPC G06F 16/2462

(57) ABSTRACT

In accordance with an embodiment, described herein are systems and methods for use of an in-memory data grid as a vector database, with linearly-scalable data ingestion, for use in generative artificial intelligence (AI), data visualization, or other applications that include the use of a large language model (LLM) or a retrieval-augmented generation (RAG) process. In accordance with an embodiment, where AI-related tasks or processes, such as content ingestion and vectorization, or vector similarity searches, can be performed in parallel, the in-memory data grid provides efficient scaling and execution of such processes. When tasked with large amounts of content to be vectorized—for example in a cloud environment or as part of an on-premise solution—the system can scale its processing of the content, in parallel where indicated, to perform an optimal utilization of available computing hardware resources, and expeditiously perform required tasks or processes.

### CLAIM OF PRIORITY AND CROSS-REFERENCE TO RELATED APPLICATIONS

This application claims the benefit of priority to U.S. Provisional Patent Application titled “SYSTEM AND METHOD FOR USE OF AN IN-MEMORY DATA GRID AS A VECTOR DATABASE”, Application No. 63/690,982, filed Sep. 5, 2024; and U.S. Provisional Patent Application titled “SYSTEM AND METHOD FOR USE OF AN IN-MEMORY DATA GRID AS A VECTOR DATABASE, FOR USE IN RETRIEVAL-AUGMENTED GENERATION”, Application No. 63/690,987, filed Sep. 5, 2024; each of which above applications and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to cloud computing, data analytics environments, or other types of computing environments, and are particularly directed to systems and methods for use of an in-memory data grid as a vector database, with linearly-scalable data ingestion, for use in generative artificial intelligence (AI), data visualization, or other applications that include large language models or retrieval-augmented generation.

### BACKGROUND

Generally described, data analytics systems and methods enable the computer-based examination of an amount of data, to derive an analytic data, metrics, conclusions, or other types of analytical information from, or descriptive of, the source data. Such systems and methods can be used, for example, to generate a set of data metrics or measures operating as key performance indicators, which analytically describe an organization's business-related data in a format useful to its decision-makers.

Some data analytics environments include the use of a large language model (LLM) that allows users to input data analytics requests in a natural language format. The system provides instructions or prompts to the LLM as a means of understanding the user input and generating a corresponding or appropriate query, for example to retrieve a particular set of data or generate a particular data visualization.

With increased interest in generative artificial intelligence (AI) systems that utilize LLMs or retrieval-augmented generation (RAG) processes to assess very large amounts of documentation or other types of data, there is an increasing requirement to efficiently store and search large numbers of dense vector embeddings, for example to support document ingestion from a wide variety of document sources for use in providing generative AI content.

### SUMMARY

In accordance with an embodiment, described herein are systems and methods for use of an in-memory data grid as a vector database, with linearly-scalable data ingestion, for use in generative artificial intelligence (AI), data visualization, or other applications that include the use of a large language model (LLM) or a retrieval-augmented generation (RAG) process.

In accordance with an embodiment, where AI-related tasks or processes, such as content ingestion and vectorization, or vector similarity searches, can be performed in parallel, the use of an in-memory data grid provides efficient scaling and execution of such processes. When tasked with large amounts of content to be vectorized—for example in a cloud environment or as part of an on-premise solution—the system can scale its processing of the content, in parallel where indicated, to perform an optimal utilization of available computing hardware resources, and expeditiously perform required tasks or processes.

In accordance with an embodiment, the in-memory data grid provides functionality to represent content as document chunks containing text, embedding, and metadata, which allows the system to support a variety of RAG framework integrations in a consistent manner. To further support the use of RAG processes, the system can support document ingestion via various types of document sources, such as the use of HTTP URLs that allow retrieval of documents using HTTP GET calls; or, for example in cloud environments, the use of object storage and/or other cloud provider storage services as appropriate.

### BRIEF DESCRIPTION OF THE DRAWINGS

FIG. 1 illustrates an example cloud computing environment, in accordance with an embodiment.

FIG. 2 further illustrates an example cloud computing environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a large language model, in accordance with an embodiment.

FIG. 10 further illustrates an example data analytics environment, including the use of retrieval-augmented generation, in accordance with an embodiment.

FIG. 11 illustrates an example of an in-memory data grid, in accordance with an embodiment.

FIG. 12 illustrates the use of an in-memory data grid as a vector database, in accordance with an embodiment.

FIG. 13 further illustrates the use of an in-memory data grid as a vector database, in accordance with an embodiment.

FIG. 14 illustrates an example use of an in-memory data grid as a vector database, in accordance with an embodiment.

FIG. 15 further illustrates an example use of an in-memory data grid as a vector database, in accordance with an embodiment.

FIG. 16 illustrates a method for use of an in-memory data grid as a vector database, in accordance with an embodiment.

FIG. 17 illustrates an example system that includes the use of an in-memory data grid as a vector database, in accordance with an embodiment.

FIG. 18 further illustrates an example system that includes the use of an in-memory data grid as a vector database, in accordance with an embodiment.

FIG. 19 illustrates the use of an in-memory data grid as a vector database for use in retrieval-augmented generation, in accordance with an embodiment.

FIG. 20 illustrates an example use of an in-memory data grid as a vector database in retrieval-augmented generation, in accordance with an embodiment.

FIG. 21 illustrates a method for use of an in-memory data grid as a vector database in retrieval-augmented generation, in accordance with an embodiment.

FIG. 22 illustrates an example method for use of an in-memory data grid as a vector database in retrieval-augmented generation, in accordance with an embodiment.

### DETAILED DESCRIPTION

Generally described, data analytics systems and methods enable the computer-based examination of an amount of data, to derive an analytic data, metrics, conclusions, or other types of analytical information from, or descriptive of, the source data. Such systems and methods can be used, for example, to generate a set of data metrics or measures operating as key performance indicators, which analytically describe an organization's business-related data in a format useful to its decision-makers.

Some data analytics environments include the use of a large language model (LLM) that allows users to input data analytics requests in a natural language format. The system provides instructions or prompts to the LLM as a means of understanding the user input and generating a corresponding or appropriate query, for example to retrieve a particular set of data or generate a particular data visualization.

With increased interest in generative artificial intelligence (AI) systems that utilize LLMs or retrieval-augmented generation (RAG) processes to assess very large amounts of documentation or other types of data, there is an increasing requirement to efficiently store and search large numbers of dense vector embeddings, for example to support document ingestion from a wide variety of document sources for use in providing generative AI content.

In accordance with an embodiment, described herein are systems and methods for use of an in-memory data grid as a vector database, with linearly-scalable data ingestion, for use in generative artificial intelligence (AI), data visualization, or other applications that include the use of a large language model (LLM) or a retrieval-augmented generation (RAG) process.

In accordance with an embodiment, where AI-related tasks or processes, such as content ingestion and vectorization, or vector similarity searches, can be performed in parallel, the use of an in-memory data grid provides efficient scaling and execution of such processes. When tasked with large amounts of content to be vectorized—for example in a cloud environment or as part of an on-premise solution—the system can scale its processing of the content, in parallel where indicated, to perform an optimal utilization of available computing hardware resources, and expeditiously perform required tasks or processes.

In accordance with an embodiment, the in-memory data grid provides functionality to represent content as document chunks containing text, embedding, and metadata, which allows the system to support a variety of RAG framework integrations in a consistent manner. To further support the use of RAG processes, the system can support document ingestion via various types of document sources, such as the use of HTTP URLs that allow retrieval of documents using HTTP GET calls; or, for example in cloud environments, the use of object storage and/or other cloud provider storage services as appropriate.

### Cloud Computing Environments

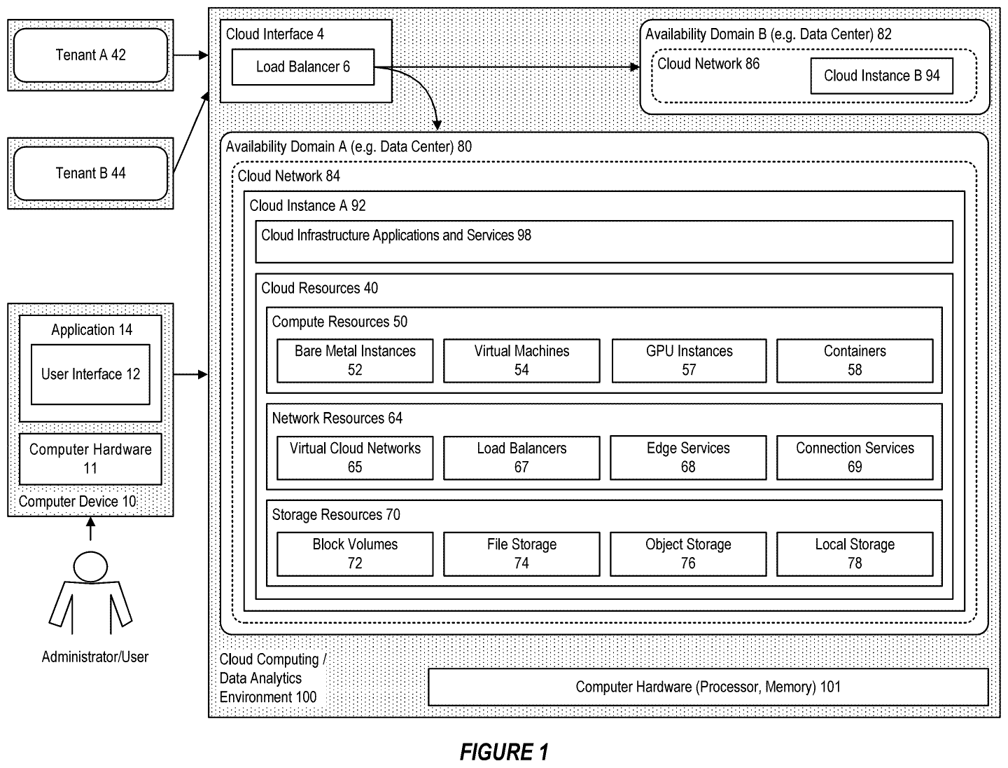

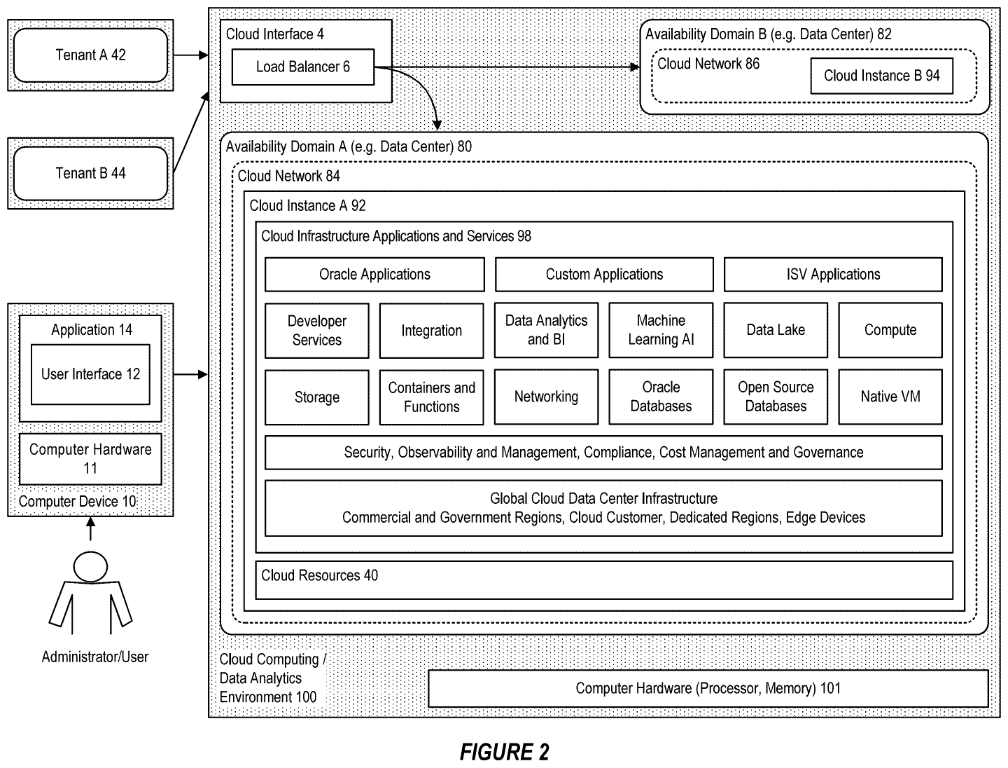

FIGS. 1 and 2 illustrate an example cloud computing environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide cloud environments for use by tenants in accessing subscription-based software products, services, or other offerings associated with a cloud infrastructure environment. In accordance with other embodiments, the various components, processes, and features described herein can be used with other types of cloud computing environments.

As illustrated in FIG. 1, in accordance with an embodiment, a cloud computing or data analytics environment 100 can operate on a cloud computing infrastructure comprising hardware 101 (e.g., processor, memory), software resources, and one or more cloud interfaces 4 or other application program interfaces (API) that provide access to the shared cloud resources via one or more load balancers 6.

In accordance with an embodiment, the cloud computing or data analytics environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud computing or data analytics environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud computing or data analytics environment via a network such as, for example, a wide area network, local area network, or the Internet, to create or update cloud services.

In accordance with an embodiment, the cloud computing or data analytics environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud computing or data analytics environment can provide control of physical host (bare metal) machines within the compute resources layer, which run as compute cloud instances directly on bare metal servers, without a hypervisor.

In accordance with an embodiment, the cloud computing or data analytics environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud computing or data analytics environment can include a range of complementary cloud-based components, for example as cloud infrastructure applications and services 98, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

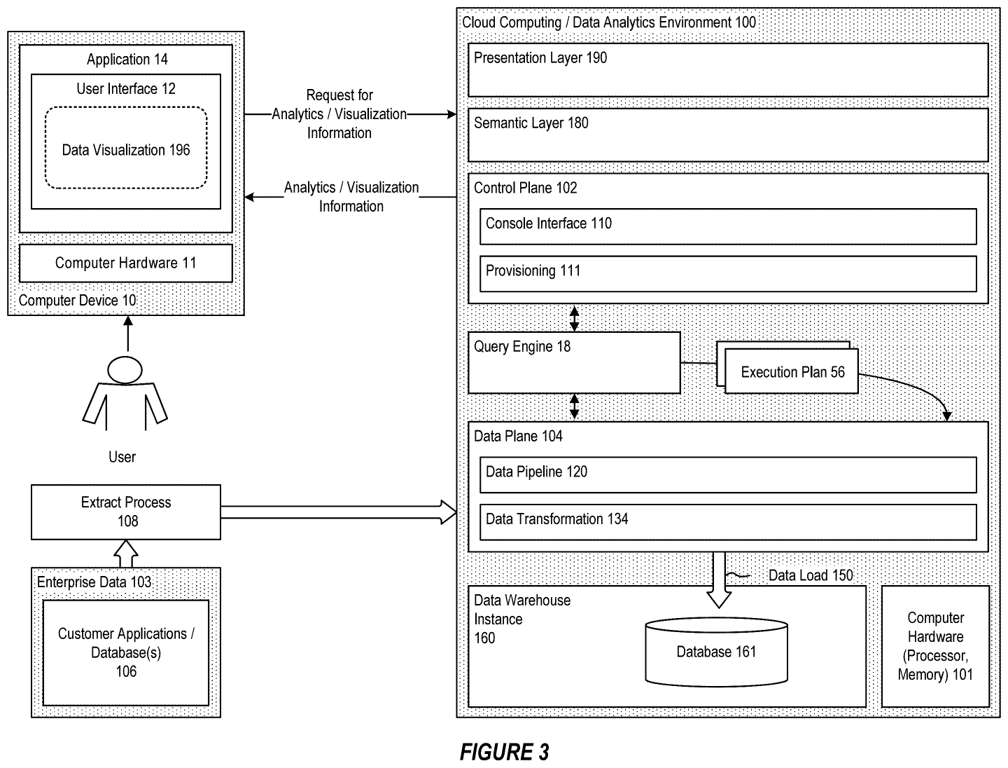

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

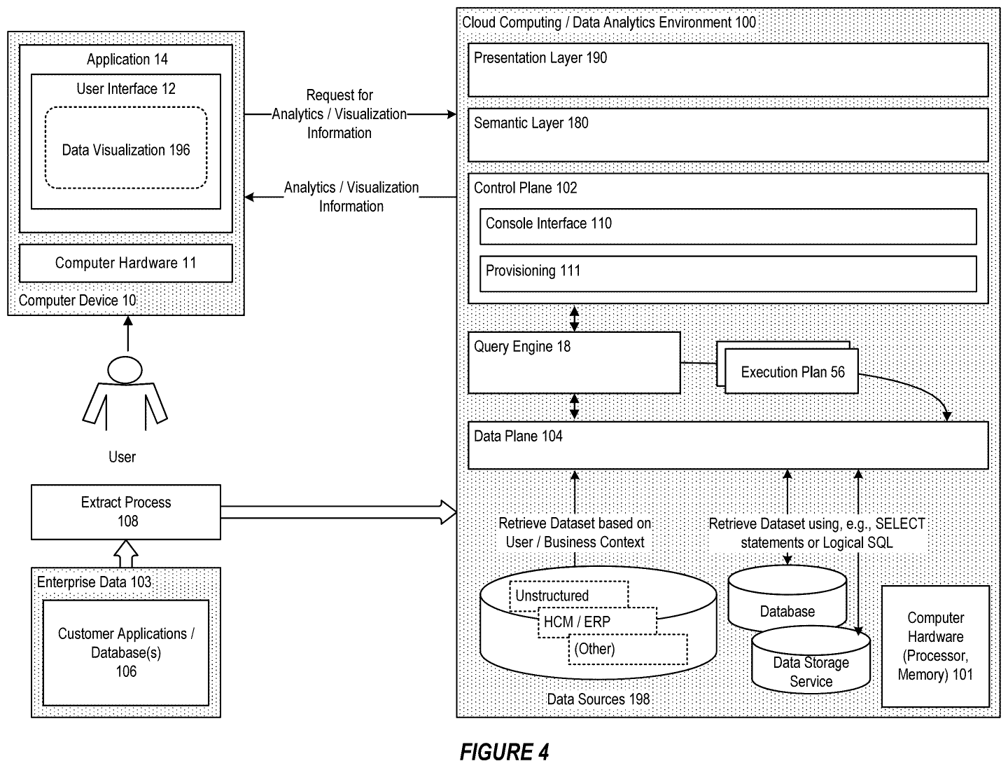

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

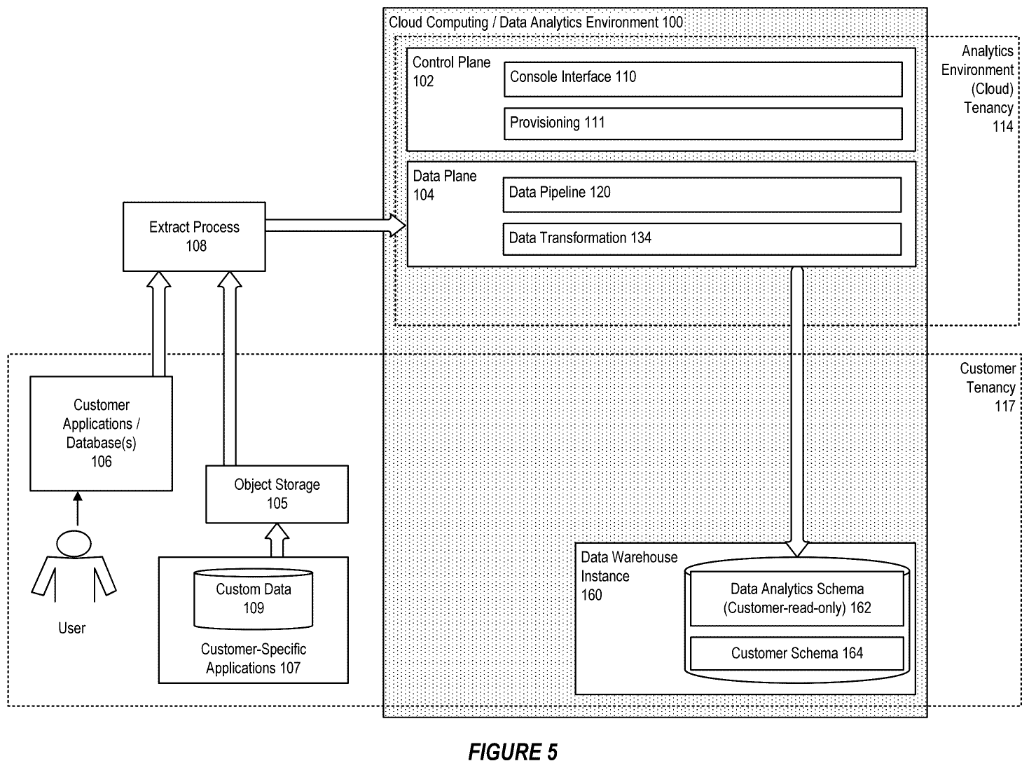

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

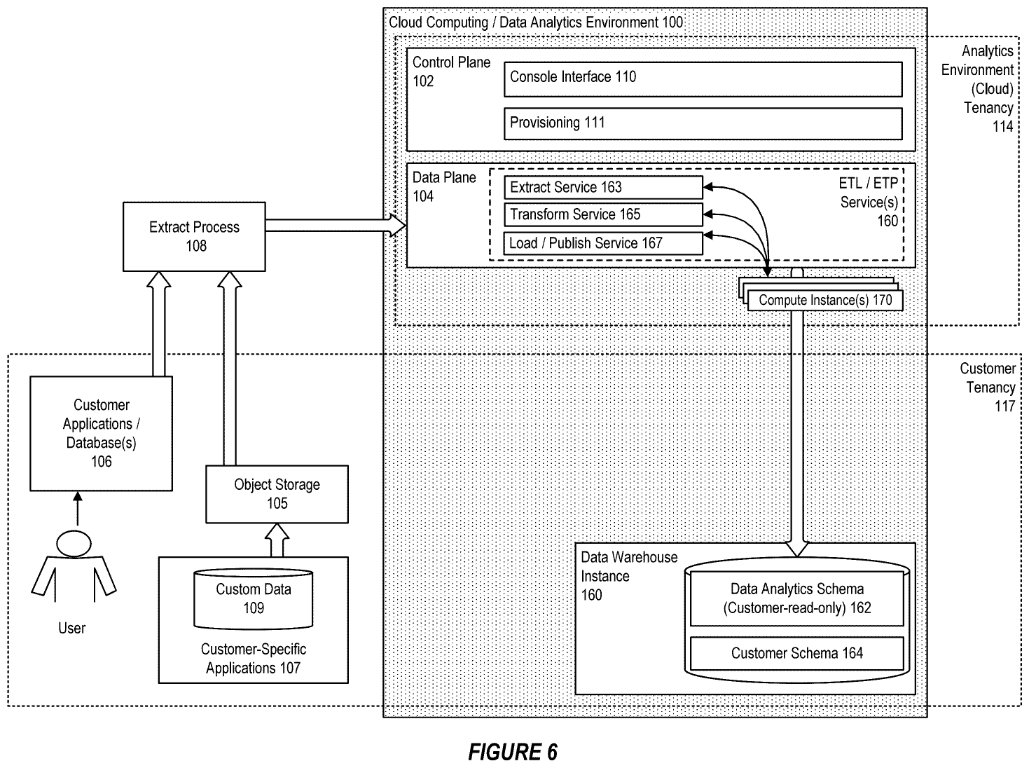

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

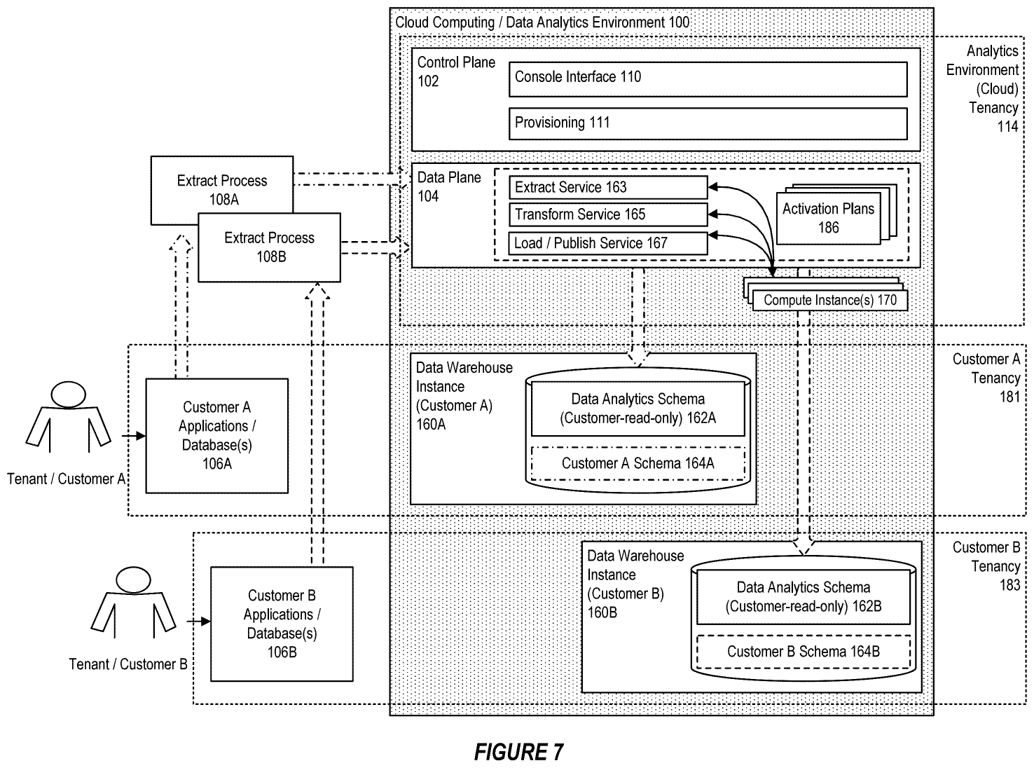

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

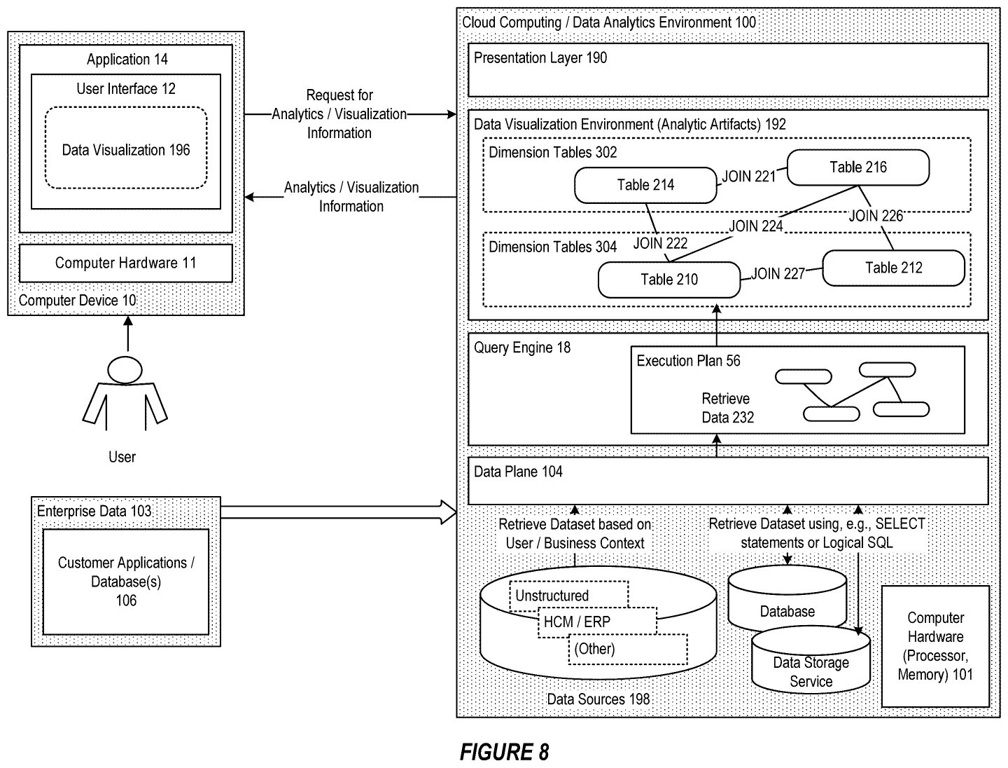

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Large Language Models (LLM)

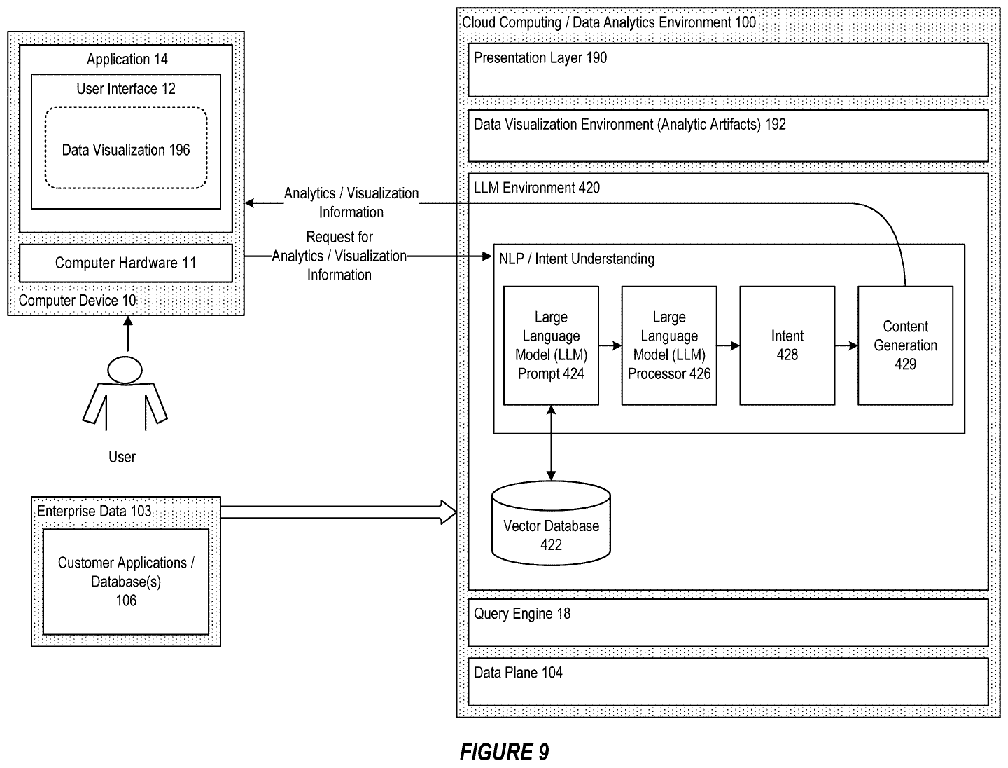

FIG. 9 further illustrates an example data analytics environment, including the use of a large language model, in accordance with an embodiment.

As illustrated in FIG. 9, in accordance with an embodiment, a data analytics system can include a large language model (LLM) environment 420. A vector database (vector store) 422 provides storage and retrieval of vectors or vector embeddings, which in turn enables LLMs to understand information with increased context and accuracy, for example in generating a requested data analytics information or data visualization.

In accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-Augmented Generation (RAG)

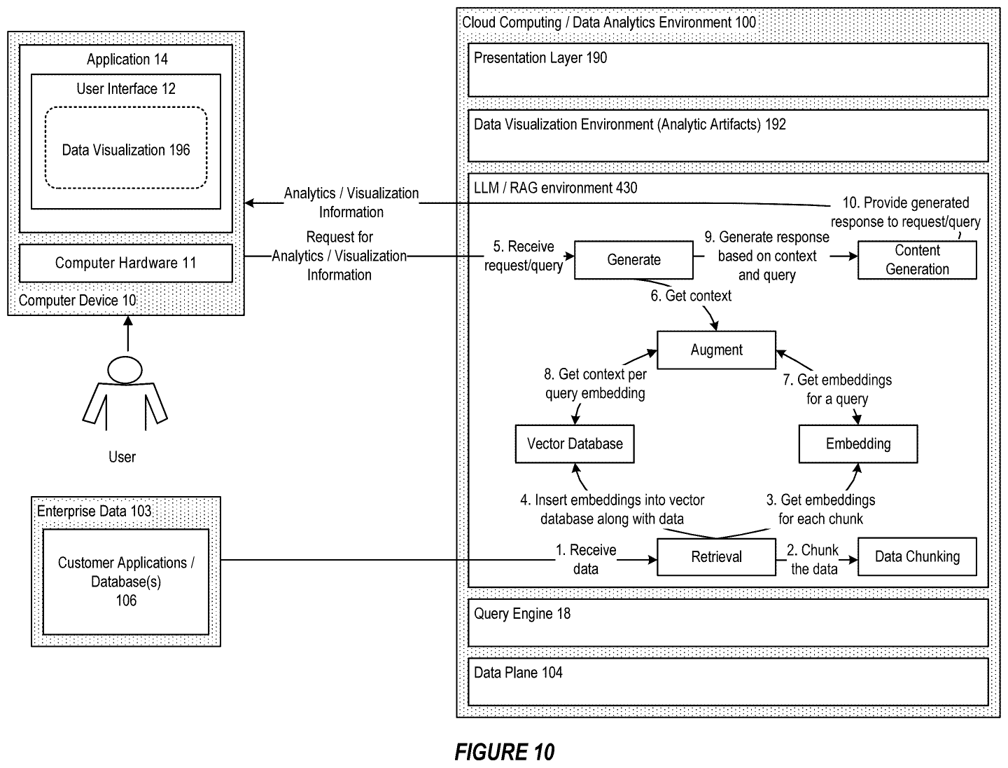

FIG. 10 further illustrates an example data analytics environment, including the use of retrieval-augmented generation, in accordance with an embodiment.

As illustrated in FIG. 10, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process:

Enterprise data can be received (1) in various formats, for example, as PDF, TXT, CSV, XML, or JSON documents, via REST, File, or other protocols.

The enterprise data or documents is broken into a plurality of segment or chunks (2).

Vector embeddings are obtained for each chunk of data (3), for example by calling a generative AI embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

### In-Memory Data Grids

In accordance with various embodiments, the systems and methods described herein can include the use of an in-memory data grid as a vector database, with linearly-scalable data ingestion, for use in generative artificial intelligence (AI), data visualization, or other applications that include large language models or retrieval-augmented generation.

Generally described, an in-memory data grid provides a distributed computing system or environment in which a collection of computer servers work together in one or more clusters to manage information and related operations such as computations. The in-memory data grid can be used to manage application objects and data that are shared across the servers; and offers a low response time, high throughput, predictable scalability, continuous availability, and information reliability. This makes an in-memory data grid well-suited for use in computationally intensive applications.

In accordance with an embodiment, examples of in-memory data grids include, e.g., Oracle Coherence environments, which can store information in-memory to achieve higher performance, and can employ redundancy in keeping copies of that information synchronized across multiple servers, thus ensuring resiliency of the system and continued availability of the data in the event of failure of any particular server.

In accordance with an embodiment, a Coherence environment having a partitioned cache is described herein, by way of illustration. In accordance with various embodiments, the systems and methods described herein can be applied to other types of in-memory data grid environments. Additionally, although specific details of a Coherence in-memory data grid or environment are described herein, in accordance with various embodiments, the systems and methods described herein may be practiced without various of these specific details. For example, particular implementations of the systems and methods described herein can, in some embodiments, exclude certain features, and/or include different, or modified features than those of the in-memory data grid described herein.

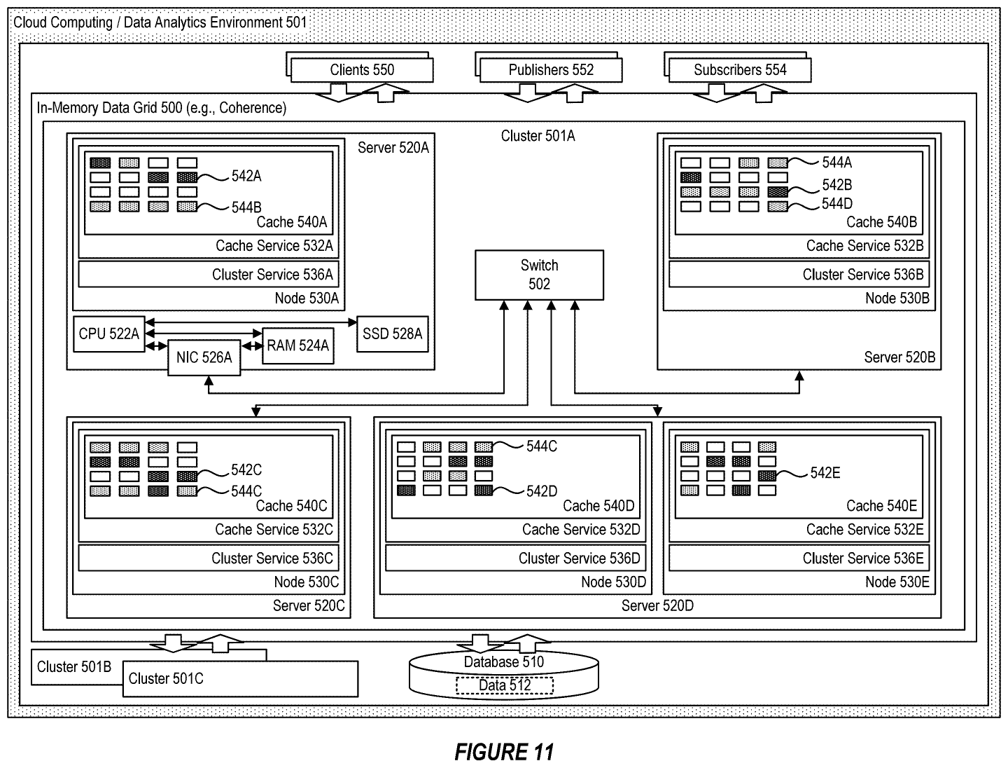

FIG. 11 illustrates an example of an in-memory data grid, in accordance with an embodiment.

As illustrated in FIG. 11, in accordance with an embodiment, an in-memory data grid can be provided by a system comprising a plurality of computer servers (e.g., 520A, 520B, 520C, and 520D) which work together in one or more clusters (e.g., 501A, 501B, 501C) to store and manage information and related operations, such as computations, within a distributed or clustered environment.

Although FIG. 11 illustrates an embodiment of an in-memory data grid 500 by way of example as comprising four servers (e.g., 520A, 520B, 520C, and 520D) with five data nodes 530A, 530B, 530C, 530D, and 530E in a cluster (e.g., 501A), in accordance with various embodiments, the in-memory data grid may comprise a number of clusters and a number of servers and/or nodes in each cluster.

In accordance with an embodiment, an in-memory data grid provides data storage and management capabilities by distributing data over a number of servers working together. Each server is configured with one or more CPU, Network Interface Card (NIC), and memory. In the illustrated example, server 520A is illustrated as having CPU 522A, Memory 524A and NIC 526A (these elements are also present but for purposes of illustration are not shown in the other Servers 520B, 520C, 520D). Optionally, each server may also be provided with a flash memory, e.g. SSD 528A, to provide spillover storage capacity. The servers in an in-memory data grid cluster can be connected using high bandwidth NICs (e.g., PCI-X or PCIe) to a high-performance network switch 502 (for example, gigabit Ethernet or better).

In accordance with an embodiment, a cluster preferably contains a minimum of four physical servers to avoid the possibility of data loss during a failure; however a typical installation may have many more servers. Generally, failover and failback are more efficient with more servers present in each cluster, and the impact of a server failure on a cluster is lessened. To minimize communication time between servers, each in-memory data grid cluster is generally confined to a single switch which provides single-hop communication between servers. In such environments, a cluster may thus be limited by the number of ports on the switch, for example to include between 4 and 96 physical servers.

In accordance with an embodiment, in some Wide Area Network (WAN) configurations of an in-memory data grid, each data center in the WAN has independent, but interconnected, in-memory data grid clusters. By using interconnected but independent clusters and/or locating interconnected, but independent, clusters in data centers that are remote from one another, the in-memory data grid can secure data and service to clients 550, publishers 552, or subscribers 554, against simultaneous loss of all servers in one cluster caused by, for example, a natural disaster, fire, flooding, or extended power loss. In this manner, clusters maintained throughout the enterprise and across geographies operate as an automatic backup store and high availability service for enterprise data.

In accordance with an embodiment, one or more nodes are provided and operate on each server of a cluster. In an in-memory data grid, the nodes may be for example, software applications, virtual machines, or the like, and the servers may comprise an operating system, hypervisor or the like on which the node operates. For example, each node can be a Java virtual machine (JVM). A number of virtual machines or nodes may be provided on each server depending on the CPU processing power and memory available on the server. Virtual machines or nodes may be added, started, stopped, and deleted as required by the in-memory data grid. For example, in a Coherence environment, virtual machines that run Coherence can automatically join a cluster when started, and are considered cluster members or cluster nodes.

In accordance with an embodiment, in a Coherence or other in-memory data grid environment, members communicate using an IP-based protocol that is used to discover cluster members, manage the cluster, provision services, and transmit data between cluster members; and provide fully reliable, in-order delivery of all messages.

In accordance with an embodiment, the functionality of an in-memory data grid cluster is based on services provided by the cluster nodes. Each service provided by a cluster node has a specific function. Each cluster node can participate in (be a member of) a number of cluster services, both in terms of providing and consuming the cluster services. Some cluster services are provided by all nodes in the cluster, whereas other services are provided by only one or only some of the nodes in a cluster. Generally described, each service has a service name that uniquely identifies the service within the in-memory data grid cluster, and a service type, which defines the service's capabilities. There may be multiple named instances of each service type provided by nodes in the in-memory data grid cluster (other than the root cluster service). All services preferably provide failover and failback without any data loss.

In accordance with an embodiment, each service instance provided by a cluster node typically uses one service thread to provide the specific functionality of the service. For example, a distributed cache service provided by a node can be provided by a single service thread of the node. When the schema definition for a distributed cache is parsed in the virtual machine or node, a service thread is instantiated with the name specified in the schema. This service thread manages the data in the cache created using the schema definition. Some services optionally support a thread pool of worker threads that can be configured to provide the service thread with additional processing resources. The service thread cooperates with the worker threads in the thread pool to provide the specific functionality of the service.

In accordance with an embodiment, the cluster service (e.g., 536A, 536B, 536C, 536D, 536E) keeps track of the membership and services in the cluster. Generally, each cluster node has exactly one service of this type running. The cluster service is automatically started to enable a cluster node to join the cluster. The cluster service is responsible for the detection of other cluster nodes, for detecting the failure of a cluster node, and for registering the availability of other services in the cluster. A proxy service allows connections (e.g., using TCP) from clients that run outside the cluster. An invocation service allows application code to invoke agents to perform operations on any node in the cluster, or any group of nodes, or across the entire cluster. Agents allows for execution of code/functions on nodes of the in-memory data grid (typically the same node as data required for execution of the function is required). Distributed execution of code, such as agents, on the nodes of the cluster allows the in-memory data grid to operate as a distributed computing environment.

In accordance with an embodiment, the distributed cache service (e.g., 532A, 532B, 532C, 532D, 532E) is the service which provides for data storage in the in-memory data grid, and is operative on all nodes of the cluster that read/write/store cache data, even if the node is storage disabled. The distributed cache service allows cluster nodes to distribute (partition) data across the cluster so that each piece of data in the cache is managed primarily (held) by only one cluster node. The distributed cache service handles storage operation requests such as put, get, etc. The distributed cache service manages distributed caches (e.g., 540A, 540B, 540C, 540D, 540E) defined in a distributed schema definition and partitioned among the nodes of a cluster.

In accordance with an embodiment, a partition is the basic unit of managed data in the in-memory data grid and stored in the distributed caches. The data is logically divided into primary partitions (e.g., 542A, 542B, 542C, 542D, and 542e), that are distributed across multiple cluster nodes, such that exactly one node in the cluster is responsible for each piece of data in the cache. Each cache can hold a number of partitions, and each partition may hold one datum or it may hold many. A partition can be migrated from the cache of one node to the cache of another node when necessary or desirable. For example, when nodes are added to the cluster, the partitions are migrated so that they are distributed among the available nodes including newly added nodes. In a non-replicated in-memory data grid there is only one active copy of each partition (the primary partition). However, there is typically also one or more replica/backup copy of each partition (stored on a different server) which is used for failover. Because the data is spread out in partition distributed among the servers of the cluster, the responsibility for managing and providing access to the data is automatically load-balanced across the cluster.

In accordance with an embodiment, the distributed cache service can be configured so that each piece of data is backed up by one or more other cluster nodes to support failover without any data loss. For example, each partition is stored in a primary partition (e.g., dark shaded squares 542A, 542B, 542C, 542D, and 542e) and one or more synchronized backup copy of the partition (e.g., light shaded squares 544A, 544B, 544C, 544D, and 544E). The backup copy of each partition is stored on a separate server/node than the primary partition with which it is synchronized. Failover of a distributed cache service on a node involves promoting the backup copy of the partition to be the primary partition. When a server/node fails, all remaining cluster nodes determine which backup partitions they hold for primary partitions on the failed node. The cluster nodes then promote the backup partitions to primary partitions on whatever cluster node they are held (and new backup partitions are then created).

In accordance with an embodiment, a distributed cache is a collection of data objects. Each data object/datum can be, for example, the equivalent of a row of a database table. Each datum is associated with a unique key which identifies the datum. Each partition may hold one datum or it may hold many, and the partitions are distributed among all the nodes of the cluster. In, for example, a Coherence environment, each key and each datum is stored as a data object serialized in an efficient uncompressed binary encoding called Portable Object Format (POF).

In accordance with an embodiment, in order to find a particular datum, each node has a map, for example a hash map, which maps keys to partitions. The map is known to all nodes in the cluster and is synchronized and updated across all nodes of the cluster. Each partition has a backing map which maps each key associated with the partition to the corresponding datum stored in the partition. An operation associated with a particular key/datum can be received from a client at any node in the in-memory data grid. When the node receives the operation, the node can provide direct access to the value/object associated with the key, if the key is associated with a primary partition on the receiving node. If the key is not associated with a primary partition on the receiving node, the node can direct the operation directly to the node holding the primary partition associated with the key (in one hop). Thus, using the hash map and the partition maps, each node can provide a direct or one-hop access to every datum corresponding to every key in the distributed cache.

In accordance with an embodiment, in some applications, data in the distributed cache is initially populated from a database 510 comprising data 512. The data in the database is serialized, partitioned and distributed among the nodes of the in-memory data grid. The in-memory data grid stores data objects created from the data in the database in partitions in the memory of servers, such that clients and/or applications in in-memory data grid can access those data objects directly from memory. Reading from and writing to the data objects using the in-memory data grid is much faster and allows more simultaneous connections than could be achieved using the database directly. In-memory replication of data and guaranteed data consistency make the in-memory data grid suitable for managing transactions in memory until they are persisted to an external data source such as database for archiving and reporting. If changes are made to the data objects in memory, the changes are synchronized between primary and backup partitions, and may subsequently be written back to database using asynchronous writes (write behind) to avoid bottlenecks.

In accordance with an embodiment, although the data is spread across cluster nodes, a client can connect to any cluster node and retrieve any datum. This location means that a developer does not have to develop their code based on the topology of the cache. In some embodiments, a client might connect to a particular service e.g., a proxy service, on a particular node. In other embodiments, a connection pool or load balancer may be used to direct a client to a particular node and ensure that client connections are distributed over some or all the data nodes. However connected, a receiving node in the in-memory data grid receives tasks from a client, and each task is associated with a particular datum, and must therefore be handled by a particular node. Whichever node receives a task (e.g., a call directed to the cache service) for a particular datum identifies the partition in which the datum is stored, and the node responsible for that partition. The receiving node then directs the task to the node holding the requested partition for example by making a remote cache call. Since each piece of data is managed by only one cluster node, an access over the network is only a single-hop operation. This type of access is extremely scalable, since it can use point-to-point communication and can take advantage of a switched fabric network, such as InfiniBand.

In accordance with an embodiment, similarly, a cache update operation can use the same single-hop point-to-point approach with the data being sent both to the node with the primary partition and the node with the backup copy of the partition. Modifications to the cache are not considered complete until all backups have acknowledged receipt, which guarantees that data consistency is maintained, and that no data is lost if a cluster node were to unexpectedly fail during a write operation. The distributed cache service also allows certain cluster nodes to be configured to store data, and others to be configured to not store data.

In accordance with an embodiment, an in-memory data grid can be optionally configured with an elastic data feature which makes use of solid-state devices, for example flash drives, to provide spillover capacity for a cache. Using the elastic data feature a cache is specified to use a backing map based on a RAM or DISK journal. Journals provide a mechanism for storing object state changes. Each datum/value is recorded with reference to a specific key and in-memory trees are used to store a pointer to the datum (a tiny datum/value may be stored directly in the tree). This allows some values (data) to be stored in solid-state devices while having the index/memory tree stored in memory (e.g., RAM 524A). The elastic data feature allows the in-memory data grid to support larger amounts of data per node with little loss in performance compared to completely RAM-based solutions.

In accordance with an embodiment, the use of an in-memory data grid such as, for example, a Coherence environment as illustrated above, can be used to increase system performance, through improvements in data operation latency, and the processing of data in real time, enabling applications to scale linearly and dynamically with predictable cost and resource utilization.

Additional advantages of various embodiments of in-memory data grids include that software applications can cache data within the in-memory data grid, avoiding expensive requests to back-end data sources, while providing a single, consistent view of such cached data. The reading of data from the cache is faster than querying back-end data sources, and scales naturally with the application tier. The described approach alleviates bottlenecks and data contention, improves application responsiveness, and supports parallel query and computation for data-based calculations; while also offering a fault-tolerant environment that provides data reliability, accuracy, consistency, high availability, and disaster recovery.

### Use of an In-Memory Data Grid as a Vector Database

As described above, some data analytics environments include the use of a large language model (LLM) that allows users to input data analytics requests in a natural language format. The system provides instructions or prompts to the LLM as a means of understanding the user input and generating a corresponding or appropriate query, for example to retrieve a particular set of data or generate a particular data visualization.

With increased interest in generative artificial intelligence (AI) systems that utilize LLMs or retrieval-augmented generation (RAG) processes to assess very large amounts of documentation or other types of data, there is an increasing requirement to efficiently store and search large numbers of dense vector embeddings, for example to support document ingestion from a wide variety of document sources for use in providing generative AI content.

In accordance with an embodiment, described herein are systems and methods for use of an in-memory data grid as a vector database, with linearly-scalable data ingestion, for use in generative artificial intelligence (AI), data visualization, or other applications that include the use of a large language model or a retrieval-augmented generation process.

As described above, in accordance with an embodiment, the use of an in-memory data grid such as, for example, a Coherence environment, can be used to increase system performance, through improvements in data operation latency and the processing of data in real time, enabling applications to scale linearly and dynamically with predictable cost and resource utilization.

In accordance with an embodiment, where AI-related tasks or processes, such as content ingestion and vectorization, or vector similarity searches, can be performed in parallel, the use of an in-memory data grid provides efficient scaling and execution of such processes. When tasked with large amounts of content to be vectorized—for example in a cloud environment or as part of an on-premise solution—the system can scale its processing of the content, in parallel where indicated, to perform an optimal utilization of available computing hardware resources, and expeditiously perform required tasks or processes.

In accordance with an embodiment, in addition to supporting local LLM-related model downloads, the system can support the use of remote models via, for example, a REST API or other type of interface. This allows the system to use remote embedding models provided by, for example, an Oracle Cloud Infrastructure (OCI) Generative AI service, or by third-party or commercial providers such as, for example, OpenAI, Mistral, or Cohere. In a similar fashion, the system can support the use of additional chat models and allow users to specify which model to use during provisioning.

In accordance with an embodiment, the in-memory data grid provides functionality to represent content as document chunks containing text, embedding, and metadata, which allows the system to support a variety of RAG framework integrations in a consistent manner. To further support the use of RAG processes, the system can support document ingestion via various types of document sources, such as the use of HTTP URLs that allow retrieval of documents using HTTP GET calls; or, for example in cloud environments, the use of object storage and/or other cloud provider storage services as appropriate.

In accordance with an embodiment, the system can provide the functionality described herein in a way that enables the addition of new document sources, and/or the configuration of available document sources at runtime, in order to support various cloud or on-premise use cases.

In accordance with various embodiments, additional use cases for document ingestion include, for example, the crawling of existing websites for documentation or other content, including cases where product documentation may be only provided in an HTML format on the website, but not as, e.g., PDF format documents. This is often the case for software products or other offerings that change frequently, and require corresponding frequent changes to the accompanying documentation, or for those situations where the training of the LLM may lag behind one or more product releases, even if the documentation itself is publicly available.

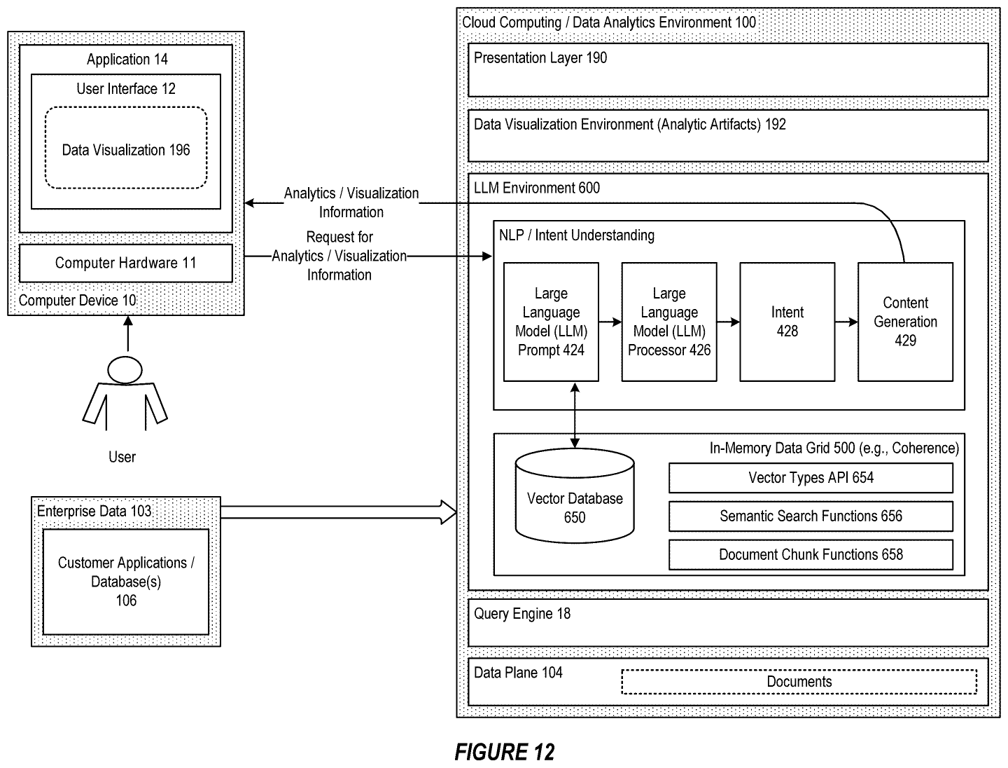

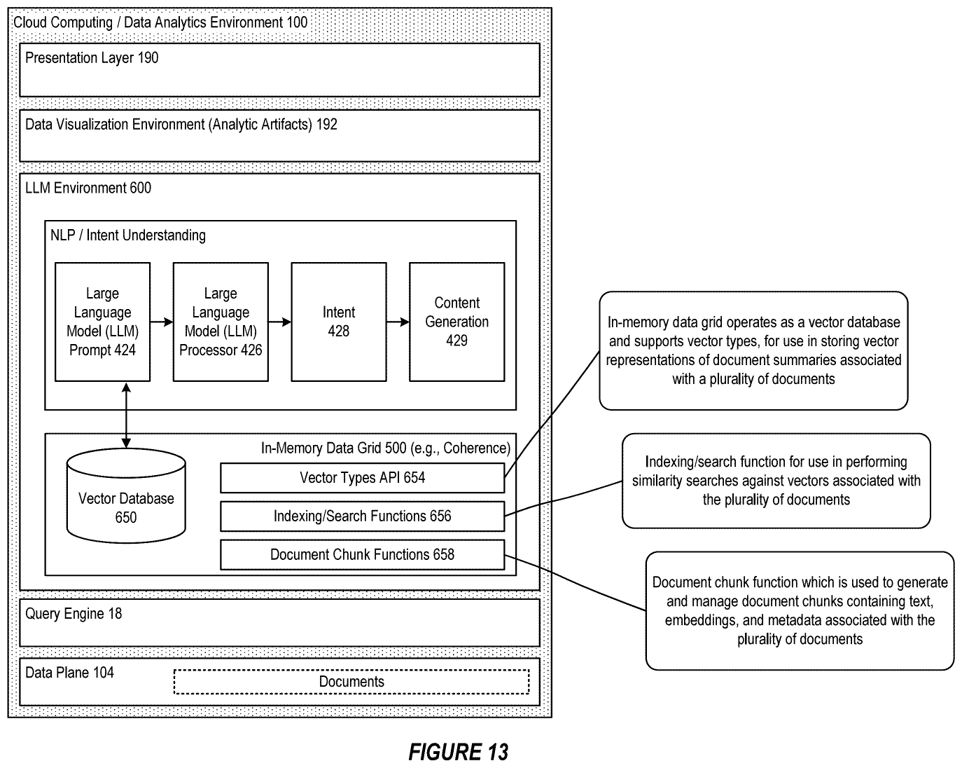

FIGS. 12-13 illustrate the use of an in-memory data grid as a vector database, in accordance with an embodiment.

As illustrated in FIGS. 12-13, in accordance with an embodiment, a cloud computing or data analytics environment can include the use of an in-memory data grid such as, for example, a Coherence environment, as part of or for use with an LLM environment 600, to address those use cases where LLM or RAG processes need to efficiently store and search large numbers of dense vector embeddings.

In accordance with an embodiment, as further described below, the system includes additional functionality that adapts an in-memory data grid 500 such as, for example, a Coherence environment as illustrated and described above, for use as a full-fledged vector database 650, including, for example:

A vector types API 654, that provides built-in support for various vector types, such as for example “float32”, “int8”, and “bit” dense vectors of arbitrary dimension.

A set of semantic search functions 656, that provide built-in support for semantic search, including for example hierarchical navigable small world (HNSW) indexing; binary quantization; index-optimized exact searches; and metadata filtering.

A set of document chunk functions 658, that provide built-in support for document chunks, addressing a common RAG use case.

In accordance with various embodiments, the system can also provide integration with software application frameworks that facilitate the integration of LLMs into applications, such as, for example, LangChain, LangChain4j, or Spring AI frameworks.

In accordance with an embodiment, the in-memory data grid can provide a number of additional features that provide efficient scaling and execution of AI-related tasks or processes, such as, for example, an efficient serialization format; the availability of filters and aggregators, which allow users to search across large data sets in parallel by leveraging all of the CPU cores in a cluster; and the use of a remote procedure call framework provisioning, such as gRPC, which allows remote clients written in a supported language, such as Python, to efficiently access data in the in-memory data grid cluster.

### Vector Types

In accordance with an embodiment, to support arbitrary vector types, the in-memory data grid provides an “com.oracle.coherence.ai.Vector<T>” interface, with three built-in implementations:
1. “BitVector”, which internally uses a “java.util.Bitset” to represent each vector element using a single bit.
2. “Int8Vector”, which internally uses a “byte[ ]”.
3. “Float32Vector”, which internally uses a “float[ ]”.

These vector types allow users to add a vector property to their own classes in the same way they would add any other property, by creating a field and accessors for it.

In accordance with an embodiment, the system can provide a “summaryEmbedding” field that is used to store a vector representation of a document “summary” field, so that the system can use vector similarity to, for example, search among book summaries. The “summaryEmbedding” property can be used to define both standard and vector indexes, and to perform similarity search against them.

```
[source, java]
.Book.java
----
@PortableType(id = 2001)
public class Book
  {
  @Portable private String isbn;
  @Portable private String title;
  @Portable private String author;
  @Portable private String summary;
  @Portable private Vector<float [ ]> summaryEmbedding;
  // constructors, getters and setters omitted
  }
----
```

### Similarity Search

In accordance with an embodiment, to perform similarity search against vectors stored in the in-memory data grid, the system can provide a “SimilaritySearch” aggregator, which a user can construct using an “Aggregators.similaritySearch” factory method. The user can specify three arguments when constructing the “SimilaritySearch” aggregator:
1. A “ValueExtractor” that should be used to retrieve the vector attribute from the map entries.
2. The search vector to compare the extracted values with.
3. The maximum number of the results to return.

For example, to search the map containing “Book” objects, and return up to ten most similar books, the user can create a “SimilaritySearch” aggregator instance such as:

[source, java]
----
var searchVector = createEmbedding(searchQuery); // outside of Coherence
var search = Aggregators.similaritySearch(Book::getSummaryEmbedding, searchVector, 10);
----

In accordance with an embodiment, by default, the aggregator uses a cosine distance function to calculate distance between vectors; the user can change this by calling a fluent “algorithm” method on the created aggregator instance and passing an instance of a different “DistanceAlgorithm” implementation, for example:

[source, java]
----
var search = Aggregators.similaritySearch(Book::getSummaryEmbedding,
searchVector, 10).algorithm(new L2SquaredDistance( ));
----

In accordance with an embodiment, an in-memory data grid such as, for example, a Coherence environment provides “CosineDistance”, “L2SquaredDistance” and “InnerProductDistance” implementations; the user can add support for additional algorithms by implementing the “DistanceAlgorithm” interface. Once an instance of a “SimilaritySearch” aggregator is created, the user can perform similarity search by calling “NamedMap.aggregate” method like they normally would, for example:

[source, java]
----
NamedMap<String, Book> books = session.getMap(“books”);
List<QueryResult<String, Book>> results = books.aggregate(search);
----

The result of the search is a list of up to maximum specified “QueryResult” objects (10, in the example above), which contain an entry key, value, and calculated distance between the search vector and a vector extracted from the specified entry. The results are sorted by distance, in ascending order, from closest to farthest.

### Brute-Force Search

In accordance with an embodiment, by default, if no index is defined for the vector attribute, the in-memory data grid will perform a brute-force search by deserializing every entry, extracting the vector attribute from it, and performing a distance calculation between the extracted vector and the search vector using the specified distance algorithm.

The above approach is generally satisfactory for small or medium-sized data sets, since the in-memory data grid will still perform search in parallel across cluster members and aggregate the results, but can be inefficient as the data sets get larger, in which case using one of the supported index types (described below) is recommended. Even when using indexes, it may be beneficial to execute the same query using brute force, in order to test recall by comparing the results returned by the (approximate) index-based search, and the (exact) brute-force search.

In accordance with an embodiment, to accomplish this, the user can configure a “SimilaritySearch” aggregator to ignore any configured index and to perform a brute-force search anyway, by calling a “bruteForce” method on the aggregator instance, for example:

[source, java]
----
var search = Aggregators.similaritySearch(Book::getSummaryEmbedding,
searchVector, 10).bruteForce( );
----
==Indexed Brute-Force Search

In accordance with an embodiment, the performance of a brute-force search can be improved by creating a forward-only index on the vector attribute using “DeserializationAccelerator”:

[source, java]
----
NamedMap<String, Book> books =
session.getMap(“books”);
books.addIndex(new
DeserializationAccelerator(Book::getSummaryEmbedding));
----

In the above example, this will avoid a repeated deserialization of “Book” values when performing brute-force search, at the cost of additional memory consumed by the indexed vector instances. The search will still perform the exact distance calculation, so the results will be exact, just like with the non-indexed brute-force search.

### Index-Based Search

In accordance with an embodiment, while the brute force searches work fine with small data sets, as the data set gets larger it is recommended to create a vector index for a vector property. In accordance with an embodiment, an in-memory data grid such as, for example, a Coherence environment, supports two vector index types: a HNSW index and a binary quantization index, as further described below.

### HNSW Index

In accordance with an embodiment, a HNSW index performs an approximate vector search. The in-memory data grid uses an embedded native implementation of HNSW index implementation, so in order to use the HNSW index the user can, for example, add a dependency on “coherence-hnsw” module, which contains all Java code and pre-built native libraries for Linux, Mac, and Windows:

```
[source, xml]
----
<dependency>
  <groupId>${coherence.groupId}</groupId>
  <artifactId>coherence-hnsw</artifactId>
  <version>${coherence.version}</version>
</dependency>
----
```

Once the user adds the dependency above, the HNSW index can be created, for example:

[source, java]
----
NamedMap<String, Book> books = session.getMap(“books”);
books.addIndex(new HnswIndex<>(Book::getSummaryEmbedding, 768));
----

In this example, the first argument to the “HnswIndex” constructor is the extractor for the vector attribute to index, and the second argument is the number of dimensions each indexed vector will have (which must be identical), which will allow the native index implementation to pre-allocate memory required for the index. By default, the “HnswIndex” constructor will use the cosine distance to calculate vector distances; this can be overridden by specifying “spaceName” argument in a constructor, for example:

[source, java]
----
NamedMap<String, Book> books =
session.getMap(“books”);
books.addIndex(new
HnswIndex<>(Book::getSummaryEmbedding, “L2”, 768));
----

In accordance with an embodiment, the valid values for space name are “COSINE”, “L2” and “IP” (inner product). “HnswIndex” also provides a number of options that can be used to fine-tune its behavior, which can be specified using a fluent API:

```
[source, java]
----
var hnsw = new HnswIndex<>(Book::getSummaryEmbedding, 768)
  .setEfConstr(200)
  .setEfSearch (50)
  .setM(16)
  .setRandomSeed(100);
books.addIndex(hnsw);
----
```

In accordance with an embodiment, the user can also specify a maximum index size by calling the “setMaxElements” method. By default, the index will be created with a maximum size of 4,096 elements, and will be resized as necessary to accommodate data set growth. However, the resize operation can be costly, and can be avoided if it is known ahead of time how many entries will be stored in the, e.g., Coherence map creating the index on, in which case the index size should be configured accordingly.

In accordance with an embodiment, a distributed in-memory data grid, such as a Coherence environment, partition indexes, so there will be as many instances of HNSW index as there are partitions. This means that the ideal “maxElements” settings is just a bit over “mapSize/partitionCount”, and not the actual map size, which would be too large in practice.

In accordance with an embodiment, once the HNSW index is configured and created, the user can simply perform searches the same way as illustrated above using a brute-force search. The in-memory data grid will automatically detect and use the HNSW index, if one is available.

### Binary Quantization

In accordance with an embodiment, The In-memory data grid also supports a [Binary Quantization]-based index, which provides significant space savings compared to vector indexes that use “float32” vectors, such as HNSW. It does this by converting each 32-bit float in the original vector into either 0 or 1, and representing it using a single bit in a “BitSet”.

In some instances, recall may not be as accurate, especially with smaller vectors; however this can be largely addressed by oversampling and re-scoring of the results, which a Coherence environment automatically performs. In such an environment, the “BinaryQuantIndex” is implemented in Java, and requires no additional dependencies. To create it, the user can call the “NamedMap.addIndex” method, for example:

[source, java]
----
NamedMap<String, Book> books =
session.getMap(“books”);
books.addIndex(new
BinaryQuantIndex<>(Book::getSummaryEmbedding));
----

In accordance with an embodiment, the user can specify an “oversamplingFactor”, which is the multiplier for the maximum number of the results to return, and is 3 by default, meaning that if the search aggregator is configured to return 10 results, then the binary quantization search will initially return 30 results based on the Hamming distance between the binary representation of the search vector and index vectors, re-score all 30 results using exact distance calculation, and then re-order and return top 10 results based on the calculated exact distance. To change the “oversamplingFactor”, the user can specify it using fluent API when creating an index

[source, java]
----
NamedMap<String, Book> books = session.getMap(“books”);
books.addIndex(new
BinaryQuantIndex<>(Book::getSummaryEmbedding).oversamplingFactor(5));
----

The above example will cause the “SimilaritySearch” aggregator to return and re-score 50 results initially instead of 30, in the example above. Just like with HNSW index, once the binary quantization index is configured and created, the user can simply perform searches the same way as illustrated above using a brute-force search.

### Metadata Filtering

In accordance with an embodiment, in addition to vector-based similarity search, an in-memory data grid such as, for example, a Coherence environment allows the user to use standard Coherence filters to perform metadata-based filtering of the results. For example, if the user only wanted to search books by a specific author, they could specify a metadata filter “SimilaritySearch” aggregator should use in conjunction with a vector similarity search:

[source, java]
----
var search = Aggregators.similaritySearch(Book::getSummaryEmbedding, searchVector, 3)
.filter(Filters.equal(Book::getAuthor, “Jules Verne”));
var results = books.aggregate(search);
----

The above example should return only top 3 books written by Jules Verne, sorted according to vector similarity. Metadata filtering works the same regardless of whether a brute-force or index-based search is used, and will use any indexes associated with the metadata attributes they are filtering on, such as “Book::getAuthor” in this case, to speed up filter evaluation.

In accordance with an embodiment, the reason for setting the filter on the aggregator itself and performing filter evaluation inside the aggregator, instead of using “aggregate” method that accepts a filter and allows pre-filtering the set of entries to aggregate, is that both vector index implementations need to evaluate the filter internally, and only include the result if it evaluates to “true”—so the example above will work in all situations.

However, if using a brute-force search, the same result may be achieved, and performance likely improved, by pre-filtering the entries, for example:

[source, java]
----
var search = Aggregators.similaritySearch(Book::getSummaryEmbedding, searchVector, 3);
var results = books.aggregate(Filters.equal(Book::getAuthor, “Jules Verne”), search);
----

### Document Chunks

In accordance with an embodiment, the in-memory data grid provides functionality such as a “DocumentChunk” class, which can be used to represent content as document chunks containing text, embedding, and metadata, as might typically be represented in various retrieval-augmented generation (RAG) frameworks.

### Example Use

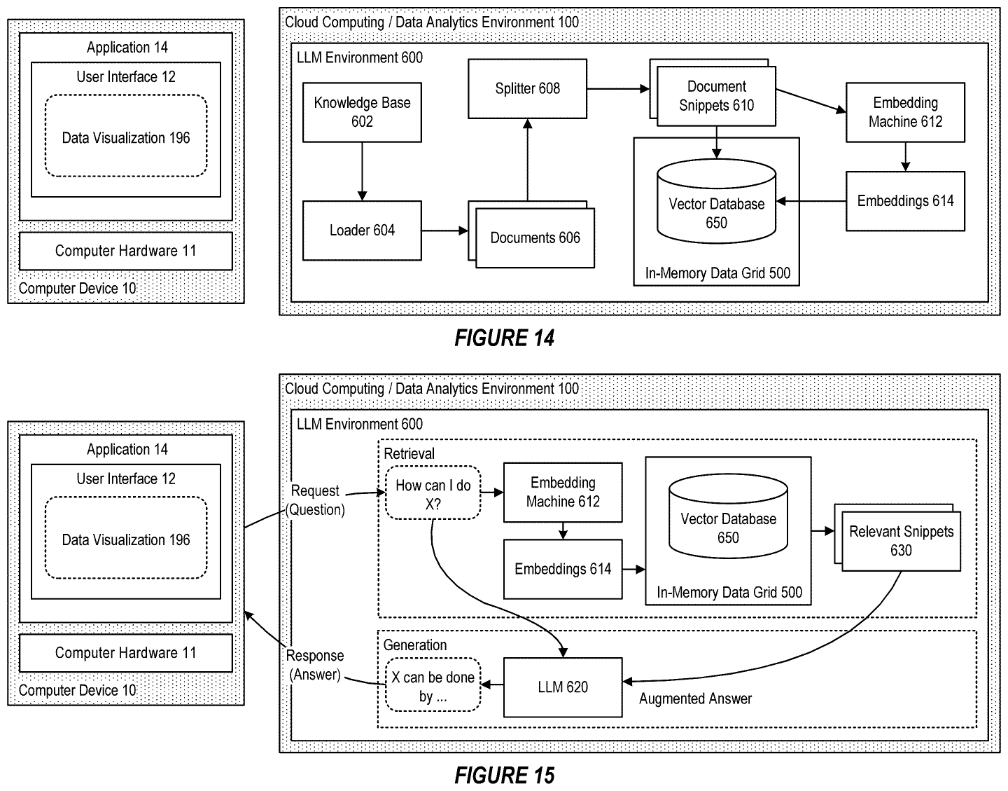

FIGS. 14 and 15 illustrates an example use of an in-memory data grid as a vector database, in accordance with an embodiment.

As illustrated by way of example in FIG. 14, in accordance with an embodiment, an in-memory data grid (500) such as, for example, a Coherence environment, can be provided as part of or for use with an LLM environment (600) that includes, in the illustrated example, a knowledge base 602, loader 604, documents 606, splitter 608, document snippets 610, and embedding machine 612, to address those use cases where LLM or RAG processes need to efficiently store and search large numbers of dense vector embeddings 614.

As illustrated by way of example in FIG. 15, in accordance with an embodiment, an in-memory data grid (500) such as, for example, a Coherence environment, can be provided as part of or for use with an LLM environment (600) that uses a RAG process in association with an LLM 620 to process user queries, requests, questions or natural language input from users, and determine relevant snippets 630 of documents or other content to be returned to the user as responses or answers.

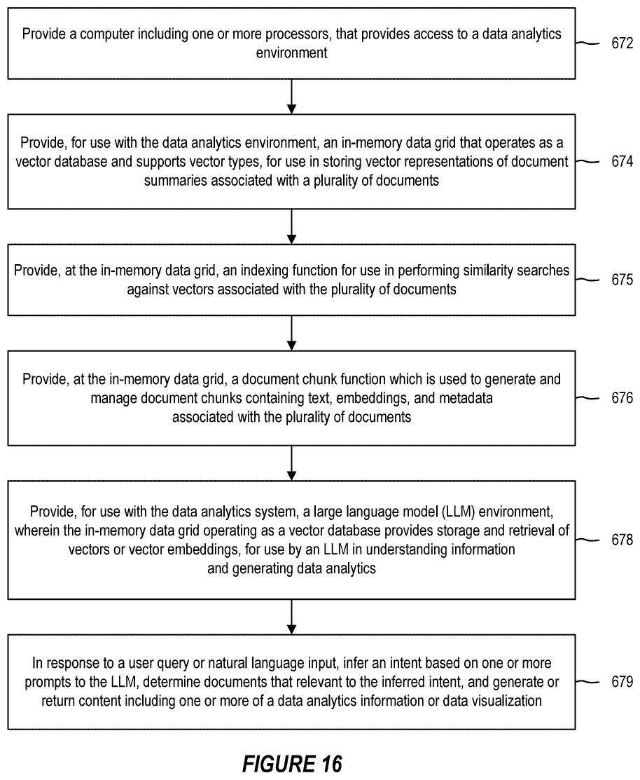

FIG. 16 illustrates a method for use of an in-memory data grid as a vector database, in accordance with an embodiment.

As illustrated in FIG. 16, in accordance with an embodiment, at step 672, the method includes providing a computer including one or more processors, that provides access to a data analytics environment.

At step 674, the method includes providing, for use with the data analytics environment, an in-memory data grid that operates as a vector database and supports vector types, for use in storing vector representations of document summaries associated with a plurality of documents.

At step 675, the method includes providing, at the in-memory data grid, an indexing function for use in performing similarity searches against vectors associated with the plurality of documents.

At step 676, the method includes providing, at the in-memory data grid, a document chunk function which is used to generate and manage document chunks containing text, embeddings, and metadata associated with the plurality of documents.

At step 678, the method includes providing, for use with the data analytics system, a large language model (LLM) environment, wherein the in-memory data grid operating as a vector database provides storage and retrieval of vectors or vector embeddings, for use by an LLM in understanding information and generating data analytics.

At step 679, in response to a user query or natural language input, the system infers an intent based on one or more prompts to the LLM, determines documents that are relevant to the inferred intent, and generates or returns content including one or more of a data analytics information or data visualization.

### Parallel Processing

As indicated above, in accordance with an embodiment, where AI-related tasks or processes, such as content ingestion and vectorization, or vector similarity searches, can be performed in parallel, the use of an in-memory data grid provides efficient scaling and execution of such processes.

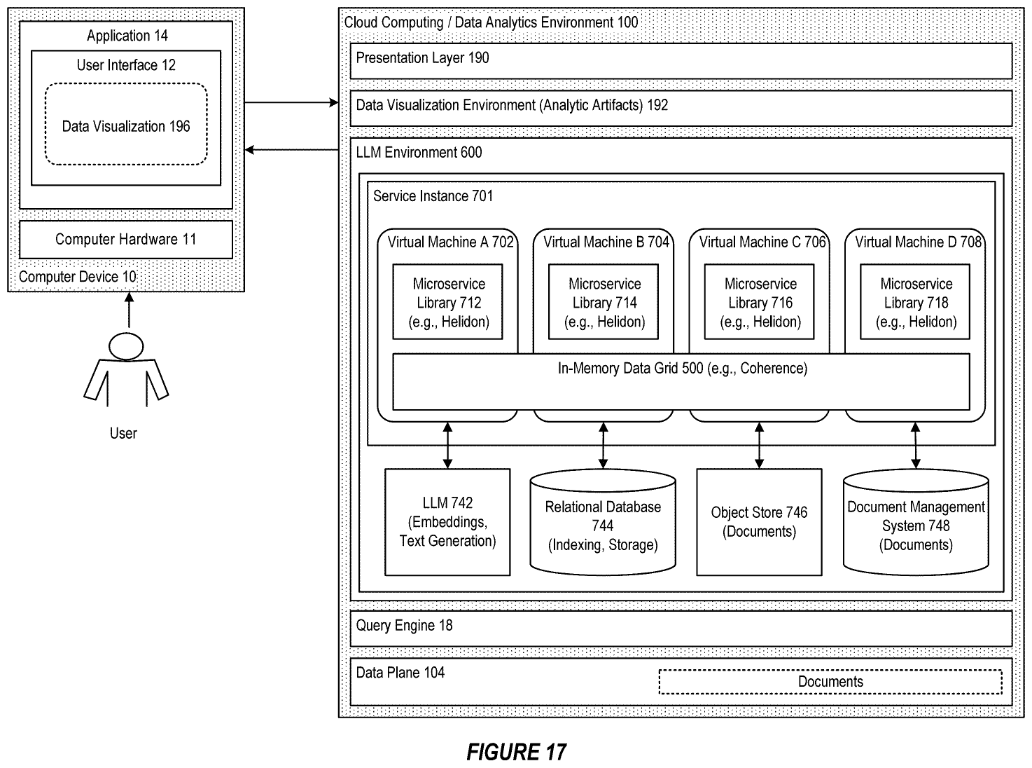

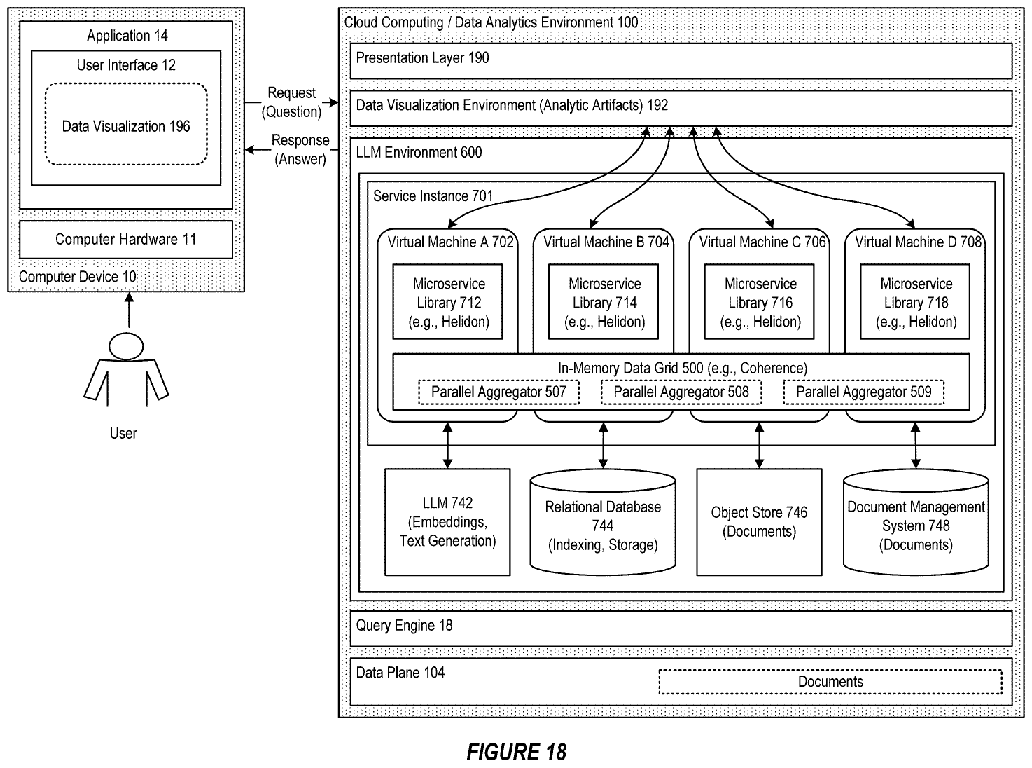

FIGS. 17-18 illustrates an example system that includes the use of an in-memory data grid as a vector database, in accordance with an embodiment.

As illustrated in FIG. 17, in accordance with an embodiment, the system can include an LLM environment (600) having a service instance 701 that operates with or is provided as multiple virtual machines (e.g., JVMs) 702, 704, 706, 708, each of which includes a microservice environment 712, 714, 716, 718, such as, for example, a Helidon environment that includes support for gRPC, and further includes access to an in-memory data grid such as, for example, a Coherence environment.

In accordance with an embodiment, the use of an in-memory data grid such as, for example, a Coherence environment, allows the multiple virtual machines to operate as an integrated system in processing requests directed to one or more distributed data. Coherence can be used as an integration layer to, for example, connect to one or more LLM or embedding model 742, relational database 744, object store 746, or document management system 748 that provides access to documents at a document store or, for example, a public website, or other document source.

As illustrated in FIG. 18, in accordance with an embodiment, when tasked with large amounts of content to be vectorized—for example in a cloud environment or as part of an on-premise solution—the system can scale its processing of the content, in parallel where indicated, to perform an optimal utilization of available computing hardware resources, and expeditiously perform required tasks or processes. In accordance with an embodiment, the system can utilize features of the in-memory data grid such as, for example, in a Coherence environment, the use of multiple parallel aggregators (e.g., Coherence aggregators) 507, 508, 509, to accomplish the in-parallel processing.

By way of example, in accordance with an embodiment, a system configured according to the described approach can be used, for example, to ingest PDF documentation for, e.g., Oracle Coherence, WLS and DB 23ai products; extract text from those documents and split the text into chunks using, e.g., Langchain4j; create vector embeddings for those chunks using a local embedding model hosted in, e.g., an Open Neural Network Exchange (ONNX) runtime, and store the embedded chunks in Coherence; perform a brute force vector search using Coherence parallel aggregators, and expose a /search endpoint via a REST API; expose a RAG-enabled /chat endpoint via a REST API; and provide a simple web user interface that allows comparison of LLM responses with and without RAG.

In accordance with various embodiments, the system can include additional components or functionality to enable the system to, for example, optionally store chunks and vectors in a database such as an Oracle DB 23ai database; make embedding and chat models configurable; keep track of ingestion and chunking metrics per document; ingest Helidon and Coherence Operator docs from GitHub; build scripts to create multi-architecture Docker images; and support use of Kubernetes (k8s) deployment scripts to run and manage the environment using a Coherence Operator.

The above examples are provided, by way of example, to illustrate various features that embodiments of the system can provide, and various examples of uses cases that can be supported. In accordance with various embodiments, the system can include additional components or functionality to address other use cases or applications.

### Use in Retrieval-Augmented Generation (RAG) or Other Applications

As indicated above, in accordance with an embodiment, the in-memory data grid provides functionality to represent content as document chunks containing text, embedding, and metadata, which allows the system to support a variety of RAG framework integrations in a consistent manner.

Generally, large language models are trained using a lot of data; however, the models may not actually be up-to-date on the most recent data. Additionally, various LLMs may not have access to internal, non-public data. For example, data analytics customers typically have a large amount of internal documents containing a vast amount of knowledge that is not easily accessible using AI processes, or by other means.

In accordance with an embodiment, to further support the use of RAG processes, the system can support document ingestion via various types of document sources, such as the use of HTTP URLs that allow retrieval of documents using HTTP GET calls; or, for example in cloud environments, the use of object storage and/or other cloud provider storage services as appropriate.

In accordance with an embodiment, a RAG process can bridge the gap in LLM-based processing by making recent and/or internal knowledge available to the LLM. The LLM can then, for example, answer questions using both its internal model and the augmented information.

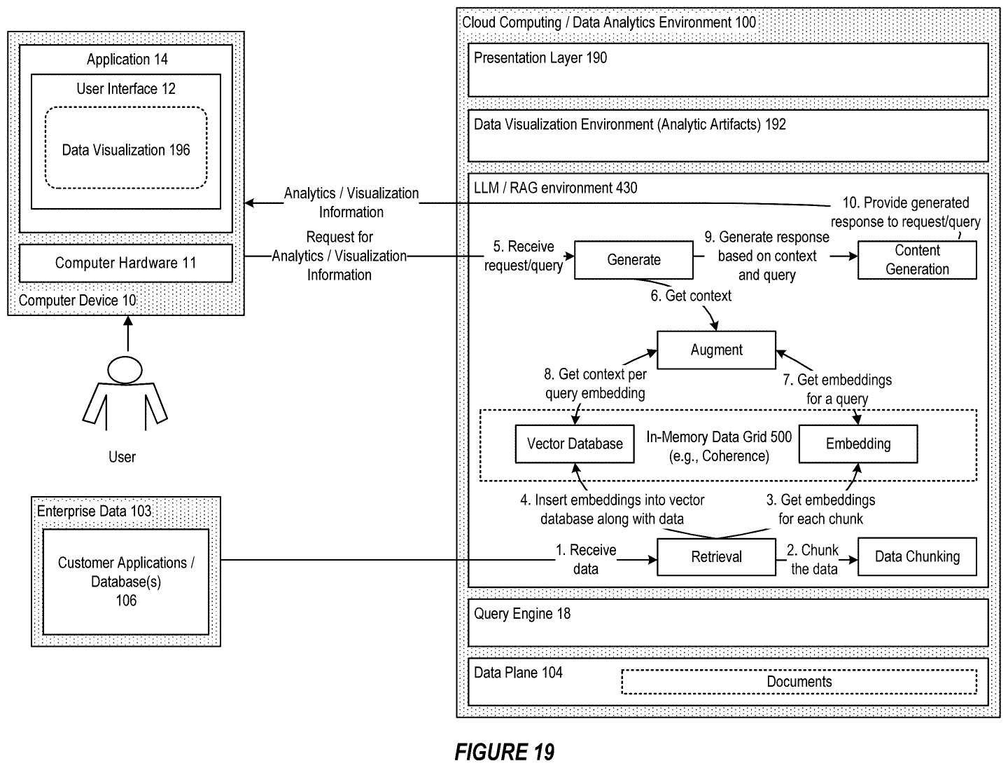

FIG. 19 illustrates the use of an in-memory data grid as a vector database for use in retrieval-augmented generation, in accordance with an embodiment.

As illustrated in FIG. 19, in accordance with an embodiment, an in-memory data grid (500) such as, for example, a Coherence environment, can be used within a retrieval-augmented generation (RAG) environment (430) as a vector database, by storing text snippets and corresponding vectors; and by returning relevant text snippets to augment an LLM context based on a vector search.

In accordance with an embodiment, the system can include additional functionality, such as, for example: content extraction and chunking in parallel; vectorization of content in a massively parallel way; integration with any document storage system to load documents from; Integration with an Oracle DB to store and index content, and perform full HNSW searches against; and/or storing of chat “memory” in the in-memory data grid for both short- and long-term processes.

For example, in accordance with an embodiment, an in-memory data grid (e.g., Coherence) cluster can receive a question from a user, for example via a user interface window, and use a RAG process to quickly determine within an indexed content a response to the question. In accordance with an embodiment, the RAG process can be used with an indexed knowledge base, wherein document text content can be parsed and used with a locally-hosted model to generate embeddings for each document, which can then be stored in the in-memory data grid. A received question and the additional relevant text snippets can be used to augment the LLM context in determining a response.

In accordance with an embodiment, the described approach provides a number of advantages or benefits, such as for example:

The system can operate to quickly ingest and vectorize content, so that end users of the RAG solution can benefit in incorporating changes to the source documents into their solution.

The system enables trying different embedding models and chunking strategies to come up with the solution that gives the best results, and to change embedding models and chunking strategies when new, better alternatives become available.

The system allows a customer/user using expensive, GPU-based machines for embeddings creation to control the cost by using those GPUs only when they really need them, and fall back to much cheaper, CPU-only machines when they don't.

The system can leverage features of an in-memory data grid such as, for example, a Coherence environment, and/or a microservices environment such as Helidon or other environments, to address retrieval augmented generation (RAG) AI use cases, including, for example:

Coherence features, such as cache stores: integration with document sources and Oracle DB; server-side events: parallel content fetching, splitting and vectorization; queries and aggregators: parallel vector-based proximity search; custom indexes: integration with Oracle DB HNSW- and IVF-based search; elastic data: to store documents, document chunks and vectors on disk.

Helidon features, such as Web Server: serve REST endpoints to expose to clients; static content; Web Client: make REST calls to fetch documents to index, create vector embeddings; Configuration: to configure various integration components (e.g., LLMs,); CDI: integration with Coherence, LLMs, DMS, DB.

Use of existing open source libraries, such as: Langchain4j: content extraction and splitting, LLM integration; ONNX Runtime: localized embeddings creation/content vectorization.

### Vector Embedding Model

In accordance with an embodiment, the approach described herein can be used to provide an objective or numerical interpretation of various aspects of interest within the data. Additionally, the described approach can make efficient use of LLMs in processing the large amounts of unstructured textual data, by scaling the processing to accommodate limitations posed by so LLMs in not being able to process large amounts of data at one time.

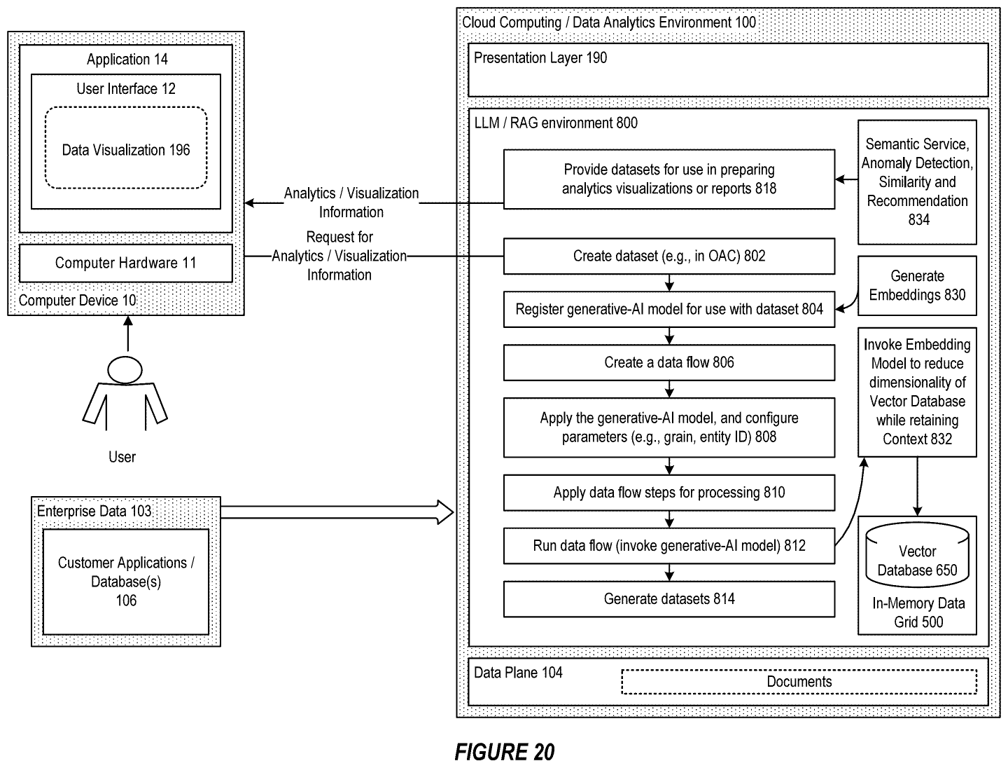

FIG. 20 illustrates an example use of an in-memory data grid as a vector database in retrieval-augmented generation, in accordance with an embodiment.

As illustrated in FIG. 20, in accordance with an embodiment, the system operates generally to: create a dataset (e.g., in OAC) (802); register a generative-AI model for use with the dataset (804); create a data flow (806); apply the generative-AI model, and configure parameters (e.g., grain, entity id) (808); apply data flow steps for processing (810); run the data flow (and invoke the generative-AI model) (812); generate datasets 814; and then provide the datasets for use in preparing data analytics visualizations (data visualizations) reports, or other types of useful information (818).

In accordance with an embodiment, when used in combination with an in-memory data grid (500) such as, for example, a Coherence environment, that operates as a vector database (650), the above-described approach can be used, for example, to generate embeddings (830); and invoke an embedding model to reduce dimensionality of the vector database while retaining context (832). The resultant vector database can then be used, for example, to provide a semantic service, anomaly detection, or similarity and recommendation services (834).

### Example Methods

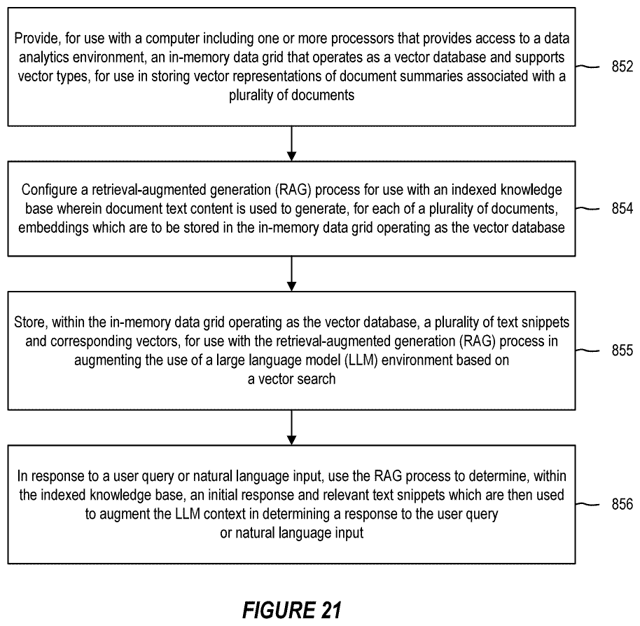

FIG. 21 illustrates a method for use of an in-memory data grid as a vector database in retrieval-augmented generation, in accordance with an embodiment.

As illustrated in FIG. 21, in accordance with an embodiment, the method comprises, at step 852, providing, for use with a computer including one or more processors that provides access to a data analytics environment, an in-memory data grid that operates as a vector database and supports vector types, for use in storing vector representations of document summaries associated with a plurality of documents.

At step 854, a retrieval-augmented generation (RAG) process is configured for use with an indexed knowledge base wherein document text content is used to generate, for each of a plurality of documents, embeddings which are to be stored in the in-memory data grid that operates as a vector database.

At step 855, the system can store, within the in-memory data grid operating as the vector database, a plurality of text snippets and corresponding vectors, for use with the retrieval-augmented generation (RAG) process in augmenting the use of a large language model (LLM) environment based on a vector search.

At step 856, in response to a user query or natural language input, the RAG process can be used to determine, within the indexed knowledge base, an initial response and relevant text snippets which are then used to augment the LLM context in determining a response to the user query or natural language input.

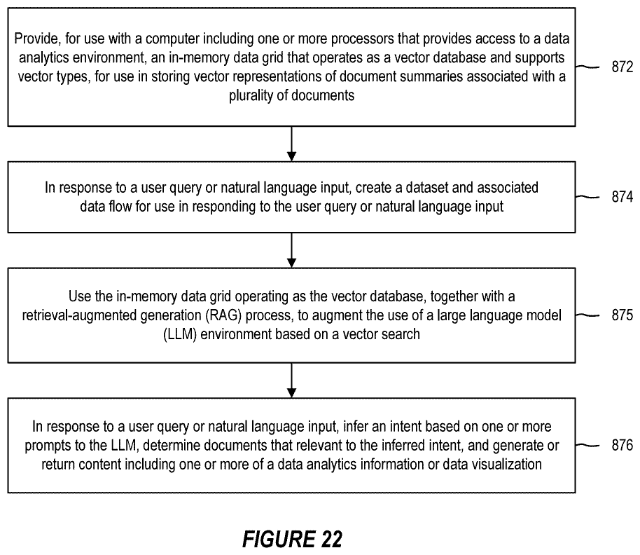

FIG. 22 illustrates an example method for use of an in-memory data grid as a vector database in retrieval-augmented generation, in accordance with an embodiment.

As illustrated in FIG. 22, in accordance with an embodiment, the method comprises, at step 872, providing, for use with a computer including one or more processors that provides access to a data analytics environment, an in-memory data grid that operates as a vector database and supports vector types, for use in storing vector representations of document summaries associated with a plurality of documents.

At step 874, in response to a user query or natural language input, a dataset and associated data flow are created for use in responding to the user query or natural language input.

At step 875, the in-memory data grid operating as the vector database, together with a retrieval-augmented generation (RAG) process, is used to augment the use of a large language model (LLM) environment based on a vector search.

At step 876, in response to a user query or natural language input, the system can infer an intent based on one or more prompts to the LLM, determine documents that relevant to the inferred intent, and generate or return content including one or more of a data analytics information or data visualization.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In accordance with an embodiment, features of the present invention can be performed in, using, or with the assistance of hardware, software, firmware, or combinations thereof. Features of the present invention may be conveniently implemented using a single or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, DSP or, any conventional processor, controller, microcontroller, or state machine or a combination of such computing devices. In some implementations, the features may be implemented by circuitry that is specific to a given function. In other implementations, the features may implemented in a system configured to perform particular functions using instructions stored e.g. on a computer readable storage media.

In accordance with an embodiment, features of the invention may also be implemented in a distributed computing environment in which one or more clusters of computers is connected by a network such as a Local Area Network (LAN), switch fabric network (e.g. InfiniBand), or Wide Area Network (WAN). In embodiments, features of the present invention are implemented, in whole or in part, in the cloud as part of a cloud computing system based on shared, elastic resources delivered to users in a self-service, metered manner using Web technologies.

In accordance with an embodiment, features of the present invention can be incorporated in software and/or firmware for controlling the hardware of a processing and/or networking system, and for enabling a processing and/or networking system to interact with other systems utilizing the features of the present invention. Such software or firmware may include, but is not limited to, application code, device drivers, operating systems, virtual machines, hypervisors, application programming interfaces, programming languages, and execution environments/containers. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

While various embodiments of the present invention have been described above, it should be understood that they have been presented by way of example, and not limitation. The described embodiments were chosen and described in order to explain the principles of the invention and its practical application. Although embodiments of the present invention have been described using a particular series of transactions and steps, it should be apparent to those skilled in the art that the scope of the present invention is not limited to the described series of transactions and steps. Further, while embodiments of the present invention have been described using a particular combination of hardware and software, it should be recognized that other combinations of hardware and software are also within the scope of the present invention.

The foregoing description has been provided for the purposes of illustration and description. It is not intended to be exhaustive or to limit the invention to the precise forms disclosed. While the various embodiments describe particular combinations of features of the invention it should be understood that different combinations of the features will be apparent to persons skilled in the relevant art as within the scope of the invention such that features of one embodiment may incorporated into another embodiment.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use of an in-memory data grid as a vector database, with linearly-scalable data ingestion, comprising:
a computer including one or more processors, and comprising an in-memory data grid, wherein the in-memory data grid provides a distributed computing system or environment in which a collection of computer servers work together in one or more clusters to manage application objects and data that are shared across the servers; and
wherein the system provides the in-memory data grid for use as a vector database, including that the system scales the processing of content, including in parallel where available, to perform an optimal utilization of available computing hardware resources.

2. The system of claim 1, wherein the system provides access to one or more of a cloud computing or data analytics environment operating thereon.

3. The system of claim 1, wherein the system comprises a vector types API, that provide support for various vector types; a set of semantic search functions, that provide support for semantic search; and a set of document chunk functions, that provide support for document chunks.

4. The system of claim 1, wherein AI-related tasks or processes, such as content ingestion and vectorization, or vector similarity searches, can be performed in parallel, the use of the in-memory data grid provides efficient scaling and execution of such processes.

5. The system of claim 1, wherein the system allows the multiple virtual machines to operate as an integrated system in processing requests directed to one or more distributed data, wherein the in-memory data grid is used as an integration layer to connect to one or more LLM or embedding model, relational database, object store, or document management system that provides access to documents at a document store or a public website, or other document source.

6. A method for use of an in-memory data grid as a vector database, with linearly-scalable data ingestion, comprising:
providing, by a computer system including one or more processors, an in-memory data grid, wherein the in-memory data grid provides a distributed computing system or environment in which a collection of computer servers work together in one or more clusters to manage application objects and data that are shared across the servers; and
wherein the system provides the in-memory data grid for use as a vector database, including that the system scales the processing of content, including in parallel where available, to perform an optimal utilization of available computing hardware resources.

7. The method of claim 6, wherein the system provides access to one or more of a cloud computing or data analytics environment operating thereon.

8. The method of claim 6, wherein the system comprises a vector types API, that provide support for various vector types; a set of semantic search functions, that provide support for semantic search; and a set of document chunk functions, that provide support for document chunks.

9. The method of claim 6, wherein AI-related tasks or processes, such as content ingestion and vectorization, or vector similarity searches, can be performed in parallel, the use of the in-memory data grid provides efficient scaling and execution of such processes.

10. The method of claim 6, wherein the system allows the multiple virtual machines to operate as an integrated system in processing requests directed to one or more distributed data, wherein the in-memory data grid is used as an integration layer to connect to one or more LLM or embedding model, relational database, object store, or document management system that provides access to documents at a document store or a public website, or other document source.

11. A non-transitory computer readable storage medium, including instructions stored thereon which when read and executed by one or more computers cause the one or more computers to perform a method comprising:
providing, by a computer system including one or more processors, an in-memory data grid, wherein the in-memory data grid provides a distributed computing system or environment in which a collection of computer servers work together in one or more clusters to manage application objects and data that are shared across the servers; and
wherein the system provides the in-memory data grid for use as a vector database, including that the system scales the processing of content, including in parallel where available, to perform an optimal utilization of available computing hardware resources.

12. The non-transitory computer readable storage medium of claim 11, wherein the system provides access to one or more of a cloud computing or data analytics environment operating thereon.

13. The non-transitory computer readable storage medium of claim 11, wherein the system comprises a vector types API, that provide support for various vector types; a set of semantic search functions, that provide support for semantic search; and a set of document chunk functions, that provide support for document chunks.

14. The non-transitory computer readable storage medium of claim 11, wherein AI-related tasks or processes, such as content ingestion and vectorization, or vector similarity searches, can be performed in parallel, the use of the in-memory data grid provides efficient scaling and execution of such processes.

15. The non-transitory computer readable storage medium of claim 11, wherein the system allows the multiple virtual machines to operate as an integrated system in processing requests directed to one or more distributed data, wherein the in-memory data grid is used as an integration layer to connect to one or more LLM or embedding model, relational database, object store, or document management system that provides access to documents at a document store or a public website, or other document source.
